(19) United States
(12) Patent Application Publication
(10) Pub. No.: US 2014/0067662 A1
(43) Pub. Date: Mar. 6, 2014

(54) Automatic machine for internet payment

(71) Applicant: Scheidt & Bachmann GmbH, Monchengladbach (DE)

(72) Inventors: Norbert Miller, Monchengladbach (DE); Matthias Augustyniak, Wegberg (DE)

(73) Assignee: Scheidt & Bachmann GmbH, Monchengladbach (DE)

(21) Appl. No.: 14/016,163

(22) Filed: Sep. 2, 2013

(30) Foreign Application Priority Data
Sep. 4, 2012 (EP) 12 182 962.6

(51) Int. Cl. G06Q 20/14

(52) U.S. Cl. CPC G06Q 20/14
USPC 705/39

(57) ABSTRACT

In a method for using an automatic machine by a user for processing a payment transaction with respect to an internet purchase between the user and an e-commerce provider, the e-commerce provider or the automatic machine requests an identification code for a payment transaction from a background system. The background system assigns an identification code, wherein the identification code identifies the internet purchase, and transmits the identification code to the e-commerce provider or the automatic machine. The e-commerce provider or the automatic machine transmits the identification code and/or a payment request to the user. The user makes a payment to the automatic machine and the automatic machine sends a confirmation of payment to the background system. Subsequently, the payment between the automatic machine and the background system and between the background system and an acquiring account is cleared.

### BACKGROUND OF THE INVENTION

The invention relates to a method for the use of an automatic machine by a user for processing a payment transaction for services or goods which have been purchased in the internet (internet purchase).

The trade with services and goods in the internet (called e-commerce) is highly appreciated by consumers, since it can be operated independently of the shop opening hours and comfortably from home. Consequently, there exists a plurality of internet shops, such as for example Amazon, e-bay, iTunes and a plurality of internet shops of other providers. Herein, the internet purchase is implemented in such a way that the user selects one or more products and informs the vendor about his/her bank account, or credit or debit card number for the purpose of payment. The bank data indicated by the user are directly checked by a background system of the e-commerce internet page with respect to for example the fact whether the bank account or also a credit card under this indicated number exist. If this so called authorization is positive, the purchase in the internet will take place.

Since however many customers do not want to disclose their own bank account or credit card numbers to the e-commerce provider in the internet, for example for reasons of data protection or because they do not possess any account or credit card, there is a series of so called prepaid schemes in the state of the art, in which so called “prepaid cards” can be charged with cash at sales outlets. The PaySafeCard may be exemplarily mentioned here which can be purchased in the retail sale. The U-Cash-Card as well as the 3V Cash-Card work according to the same principle. Besides, there are meanwhile prepaid products offered by the credit card providers themselves, for example MasterCard or Visa, which can be purchased in the retail sale or at petrol stations and can be used in the e-commerce nearly everywhere where credit cards are accepted. These cards have in common that the customer pays an amount of money in advance in order to charge the card, i.e. he/she converts the amount of the cash into electronic money by means of which he/she can then purchase products in the internet. Herein, the term “electronic money” defines a monetary value as represented by a claim on the issuer, which value is stored on an electronic device, which value is issued on receipt of funds of an amount not less in value than the monetary value issued, and which value is accepted as means of payment by undertakings other than the issuer.

Based upon the above mentioned state of the art, it is the task of the invention to create an alternative method for processing a payment transaction for an internet purchase, which payment transaction can also be processed independently from the above mentioned prepaid schemes, i.e. which does not require the acquisition of an above mentioned prepaid card and which is safe, i.e. protected against abuse by third parties, if the payment is made by means of credit or debit card.

### SUMMARY OF THE INVENTION

For accomplishing this task, the invention proposes a method, in which an automatic machine is used by a user for processing a payment transaction with respect to an internet purchase between the user and an e-commerce provider, wherein the e-commerce provider or the automatic machine requests an identification code for a payment transaction from a background system, wherein the background system assigns an identification code which identifies the internet purchase and transmits this code to the e-commerce provider or the automatic machine, wherein the e-commerce provider or the automatic machine transmits the identification code and/or a payment request to the user, the user makes a payment to the automatic machine, wherein the payment is made without cash or by means of cash, and wherein cashless payments are processed via the payment system of the automatic machine, the automatic machine sends a confirmation of payment to the background system and wherein afterwards a clearing of the payment between the automatic machine and the background system and between the background system and an acquiring account takes place.

Herein, an automatic machine, for example a ticket vending machine which is open to the public all-day at highly frequented places such as stations or traffic hubs within the city, is used for the method according to the invention. The invention is thus based upon the idea of additionally using such “conventional” vending machines which can be easily reached by everybody, but are not in use during long periods of the daytime, for processing payment transactions.

Herein, the automatic machine practically serves as encashment instrument for the payment of goods which have been purchased in the internet. Herein, this encashment instrument can be used in a completely anonymous manner and independently from the question whether the user has a bank account or a credit card. Apart from a cashless payment at the automatic machine, for example by means of a debit or credit card, the user can also make the payment by means of cash. If the user pays cashlessly by means of debit or credit card, the existing safe payment system of the automatic machine will be preferably used for the payment transaction.

Furthermore, thanks to the invention, the operators of such vending machines have the advantage that the automatic machines are used with a higher utilization frequency, whereby automatic machines can be operated overall more profitably. Herein, it is advantageous for the user to be able to execute the payment transaction for an internet purchase at any time at a correspondingly configured automatic machine without having to use a bank account or a credit card in the internet. He/she can use all payment modes which are available by the automatic machine anyway, i.e. typically including payment by cash.

The payment transaction is processed according to the invention in that a background system generates an identification code which enables an unequivocal allocation of the payment to the internet purchase. The identification code assigned by the background system also enables an unequivocal allocation of the payment to the later clearing of the acquiring account. Thus, the unequivocal identification code assures that every time the exact allocation of the payment at the automatic machine to the internet purchase or to the credit entry on the acquiring account is given. This identification code simultaneously replaces any form of prepaid card since the user does not pay the amount to be used for the internet purchase to the prepaid card, but to an account of a clearing center of the background system, wherein solely the identification code serves as reference.

A first preferred embodiment of the invention provides that the e-commerce provider transmits the identification code assigned by the background system to the user. For processing the payment, the user then transmits this identification code to an automatic machine. The automatic machine in turn transmits the identification code to the background system, wherein the background system verifies the identification code and transmits the amount of money which corresponds to the internet purchase to the automatic machine, wherein the automatic machine then indicates the amount to be paid to the user, for example on a display.

According to this first embodiment, the user purchases goods in the internet as usual via an e-commerce internet page. Afterwards, after having completed the purchase operation the user will receive an unequivocal identification code according to the invention from the e-commerce provider via e-mail or via SMS, for example on the screen of his computer, wherein the identification code can be indicated both in plain writing and in machine-readable form, for example as 1 or 2 dimensional bar code, wherein the machine-readable form can preferably also be printed out for the user. Later, the user will enter this identification code into an automatic machine in order to pay the equivalent value of this internet purchase by means of cash, credit or debit card. Herein, the identification code is entered via the entry means provided on this automatic machine, such as for example a touch screen, a PIN pad or also a bar code reader for reading machine-readable codes.

The e-commerce provider receives the identification code from a computer-based background system which works as clearing center between the operators of the automatic machines and the e-commerce providers. The identification code is unequivocal, i.e. the background system outputs the same identification code for open payments only once. The background system allocates the amount due unequivocally to the respective identification code. The internet server of the a-commerce provider in turn memorizes the identification code received from the background system with respect to the made internet purchase and waits for the payment transaction processed by the user at an automatic machine, which payment transaction will be arranged by the background system.

For processing the payment transaction, the user uses an automatic machine, by means of which the payment transaction according to the invention can be executed. For this purpose, the user for example selects the function according to the invention called “internet payment” on the automatic machine and enters the identification code for which he wants to make a payment on request via the user interface of the automatic machine, for example a touch screen or a keyboard. Thereupon, the automatic machine sends an inquiry to the background system for getting to know the amount which has to be paid for the entered identification code. This amount will be indicated to the user for example on a display of the automatic machine, wherein all the payment means which are provided by the automatic machine anyway—i.e. independently from the method according to the invention—will be simultaneously offered to the user for carrying out the payment transaction. After having successfully executed the payment transaction, the user will get a corresponding message and/or advantageously a written receipt from the automatic machine. Simultaneously or also in a time-delayed manner with respect to the payment transaction, the automatic machine sends an information to the background system confirming that a certain amount has been paid for a particular identification code. On the base of the identification code, the background system compares the amount reported by the automatic machine to the amount which is claimed by the internet server of the e-commerce provider. If the paid amount at least reaches the claimed amount, the background system confirms the complete payment of the internet purchase which belongs to this identification code to the internet server of the e-commerce provider by means of electronic information. Then, the e-commerce provider registers the complete payment of the purchase that belongs to the identification code and delivers the goods or the ordered services to the user.

Afterwards, the clearing of the payment between the automatic machine and the background system or between the background system and an acquiring account which is in this case the account of the e-commerce provider is executed. In this way, the amounts which have been encashed by the automatic machine are cleared between the clearing center (the operator of the background system according to the invention) and the operator of the automatic machine or the e-commerce provider.

According to a second embodiment of the invention, the method for the use of an automatic machine by a user for processing a payment transaction is designed such that the user transmits information about a payment acquiring account to the automatic machine. This payment acquiring account can advantageously be the user's own account. Herein, in particular an internet account such as for example a PayPal account comes into consideration, Apart from this “charging” an own account, it is however alternatively possible to credit an amount to a foreign acquiring account, for example an account of an e-commerce provider. After the user has processed the payment transaction by means of an automatic machine according to the invention, the background system transfers a credit entry to the payment acquiring account after receipt of the confirmation of payment from the automatic machine.

For this second embodiment of the invention, the user consequently holds a personal account for electronic money which is for example kept in the internet, such as a PayPal or Skrill account. The term “payment acquiring account” can also mean a prepaid card, such as for example a PaySafeCard, a U-CashCard or a 3V-Cash-Card. For “charging” this account or this card at an automatic machine, the user selects the function according to the invention which is called “charging” at the respective automatic machine, and on request by the automatic machine he/she enters, via the user interface, the information for which account or for which card he/she wants to execute the payment transaction. Afterwards, the automatic machine inquires at the background system, whether this account or this card exists and whether payment transactions are possible. Via the user interface of the automatic machine, the user can select the amount of a payment transaction. The automatic machine then guides the user through the procedure of the payment transaction, wherein it offers the user all payment means which are available at the respective automatic machine. If the user for example selects payment by cash, the user will hand over a corresponding amount to the automatic machine during the payment transaction. At the end of the payment transaction the user will receive a corresponding message and/or a written receipt from the automatic machine. Simultaneously or also in a time-delayed manner, the automatic machine sends electronic information to the background system about the fact that a certain amount has come in with respect to a particular acquiring account or a particular card. On the base of the identification code that has been disclosed by the background system, the operator of the acquiring account or the card will correspondingly increase the balance of the respective account. The electronic money can now be used in the usual way for carrying out internet purchases from e-commerce providers.

Finally, a third embodiment of the invention provides a method for the use of an automatic machine by a user for processing a payment transaction, in which the identification code transmitted by the background system to the automatic machine enables an unequivocal allocation of the encashed amount.

This third embodiment has in view that the user acquires or pays a prepaid card or a shopping voucher which he/she can use for internet purchases from e-commerce providers who take part in the scheme. Herein, the identification code which has been transmitted by the background system via the automatic machine to the user serves as an equivalent of the deposited amount, i.e. as a voucher. In the sense of the invention, the internet purchase takes place after the transmission of the identification code and/or the payment of the user at the automatic machine. For paying the internet purchase, the user uses the identification code as payment means with respect to the e-commerce provider.

For carrying out this third embodiment, the user selects the function according to the invention which is called “acquiring a voucher” at the automatic machine and on request he/she enters, via the user interface of the automatic machine, the information for which amount he wants to acquire a voucher. Afterwards, the automatic machine requests an unequivocal identification code from the background system, which identification code serves as reference of the acquired voucher. Now, the user carries out the payment transaction at the automatic machine, as described before. Herein, the user can make use of all payment means which are offered by the automatic machine. After having successfully processed the payment transaction, the user will receive a corresponding message and/or a written receipt from the automatic machine. Afterwards, the automatic machine sends electronic information to the background system about the fact that a certain amount has come in with respect to a particular identification code. Herein, the identification code identifies the respective shopping voucher which the user can use for making internet purchases at an e-commerce provider. After the execution of the internet purchase, a clearing between the background system, i.e. the clearing center, and the e-commerce provider will be executed.

### BRIEF DESCRIPTION OF THE DRAWINGS

In the following, the three embodiments of the invention will be exemplarily explained in detail by means of the figures.

FIG. 1 is a block diagram according to the first embodiment of the invention.

FIG. 2 is a block diagram according to the second and third embodiments of the invention.

The individual steps of the method are represented in the figures by arrows 1-19.

### DESCRIPTION OF THE PREFERRED EMBODIMENTS

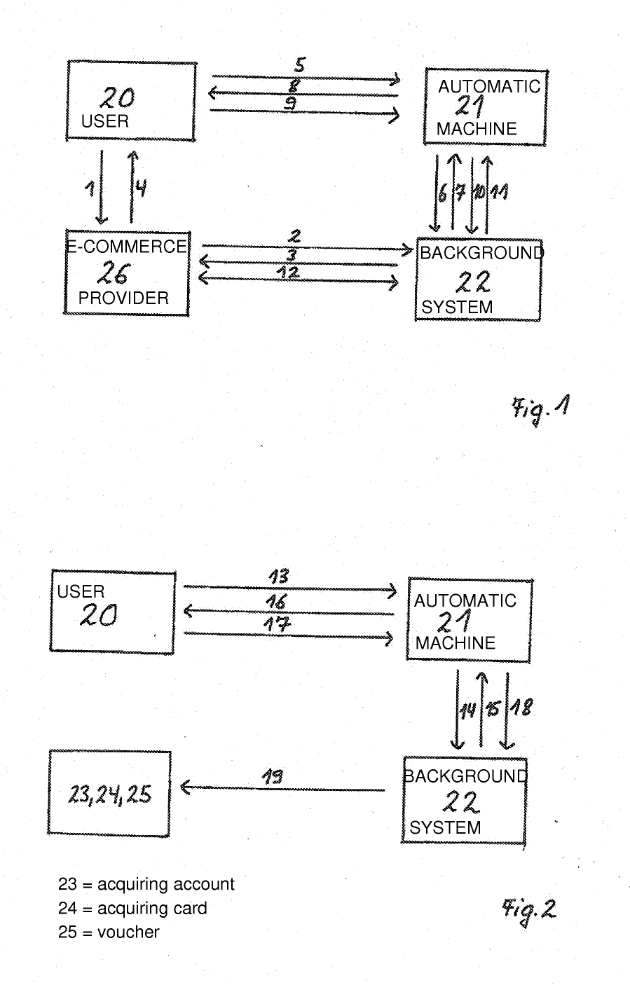

FIG. 1 represents the first embodiment of the invention, in which the user 20 makes a payment to an automatic machine 21 after having made an internet purchase. Herein, the user 20, the automatic machine 21, the background system 22 and the e-commerce provider 26 are in interaction with each other.

For carrying out the first embodiment, the user 20 makes an internet purchase 1 from the e-commerce provider 26. Afterwards, the e-commerce provider 26 requests an identification code from the background system 22 (2). The background system 22 sends an identification code to the e-commerce provider 26 (3), which is in turn transmitted to the user 20 by the e-commerce provider 26 (4). Afterwards, the user 20 uses this identification code at an automatic machine 21 which is provided for this, wherein the user 20 enters his/her identification code into the automatic machine 21 (5). Then, the automatic machine 21 inquires at the background system 22, which amount belongs to this identification code (6). The background system 22 verifies this code and discloses the associated amount (7). The automatic machine 21 outputs this amount requested from the background system 22 to the user 20 (8). Thereupon, the user 20 pays the amount requested in cash or also in a cashless manner by means of for example a debit or credit card (9). Thereupon, the automatic machine sends a message with respect to the payment transaction to the background system 22 (10). Afterwards, a clearing between the automatic machine 21 and the background system 22 (11) or between the background system and the e-commerce provider 26 (12) takes place.

According to the second embodiment of the invention that is represented in FIG. 2, the user 20 enters information about a payment acquiring account 23 (or an acquiring card 24) into the automatic machine 21 (13) in a first step of the method. Afterwards, the automatic machine 21 transmits this account number to the background system 22 and requests an identification code (14). Thereupon, the background system 22 confirms the indicated acquiring account 23 (or the acquiring card 24) and transmits an identification code to the automatic machine 21 (15). The automatic machine 21 confirms the indicated acquiring account number to the user 20 and transmits him/her the identification code (16). Thereupon, the user 20 carries out the payment transaction at the automatic machine 21 (17).

Afterwards, the automatic machine 21 sends the payment confirmation to the background system 22 (18), whereupon the background system 22 credits the acquiring account 23 (or the acquiring card 24) with the encashed amount.

According to third embodiment of the invention that is also represented in FIG. 2, the user 20 requests an identification code, for example via a function “acquisition of a voucher”, at the automatic machine 21 (13). The automatic machine 21 transmits this request to the background system 22 (14) and receives an identification code (15). This identification code is given to the user 20 as a voucher 25 (16). In return, the user pays in a desired amount equivalent to the amount of the voucher 25 (17). Afterwards, the automatic machine 21 sends a payment confirmation to the background system 22 (18), whereupon the background system 22 credits the interim account that is provided for this purpose with the paid in amount as a voucher 25 (19).

The specification incorporates by reference the entire disclosure of European priority document 12 182 962.6 having a filing date of Sep. 04, 2012.

While specific embodiments of the invention have been shown and described in detail to illustrate the inventive principles, it will be understood that the invention may be embodied otherwise without departing from such principles.

### LIST OF REFERENCE NUMERALS

1 to 19 arrow

20 user

21 automatic machine

22 background system

23 acquiring account

24 acquiring card

25 voucher

26 e-commerce provider

What is claimed is:

1. A method for using an automatic machine by a user for processing a payment transaction with respect to an internet purchase between the user and an e-commerce provider, the method comprising:
the e-commerce provider or the automatic machine requesting an identification code for a payment transaction from a background system;
the background system assigning an identification code, wherein the identification code identifies the internet purchase, and transmitting the identification code to the e-commerce provider or the automatic machine;
the e-commerce provider or the automatic machine transmitting the identification code and/or a payment request to the user;
the user making a payment to the automatic machine;
the automatic machine sending a confirmation of payment to the background system; and
subsequently, carrying out clearing of the payment between the automatic machine and the background system and between the background system and an acquiring account.

2. The method according to claim 1, wherein, in step of the user making a payment, the payment is a cashless payment carried out via the payment system of the automatic machine.

3. The method according to claim 1, wherein, in step of the user making a payment, the payment is a cash payment.

4. The method according to claim 1, wherein the identification code assigned by the background system enables an unequivocal allocation of the payment to the internet purchase.

5. The method according to claim 1, wherein the identification code assigned by the background system enables an unequivocal allocation of the payment to an offset of the payment on the acquiring account.

6. The method according to claim 1, wherein the e-commerce provider transmits the identification code assigned by the background system to the user.

7. The method according to claim 6, further comprising the step of the user transmitting the identification code to the automatic machine for carrying out the payment.

8. The method according to claim 7, further comprising the steps of the automatic machine transmitting the identification code to the background system, the background system then verifying the identification code and transmitting the amount of money corresponding to the internet purchase to the automatic machine, and the automatic machine then indicating the amount of money to the user.

9. The method according to claim 1, further comprising the step of the user transmitting information about a payment acquiring account to the automatic machine.

10. The method according to claim 9, further comprising the background system offsetting a credit entry to the payment acquiring account after receipt of confirmation of payment from the automatic machine.

11. The method according to claim 9, wherein the payment acquiring account is an account owned by the user.

12. The method according to claim 1, wherein the identification code that has been transmitted by the background system to the automatic machine enables an unequivocal allocation of the encashed amount.

13. The method according to claim 12, wherein the internet purchase takes place after the step of transmitting the identification code and/or after the step of the user making the payment at the automatic machine.

14. The method according to claim 13, wherein the user uses the identification code as a means of payment for an internet purchase between the user and an e-commerce provider.

15. The method according to claim 12, wherein the user uses the identification code as a means of payment for an internet purchase between the user and an e-commerce provider.
